(19) United States
(12) Patent Application Publication
(10) Pub. No.: US 2011/0089302 A1
(43) Pub. Date: Apr. 21, 2011

(54) SOFT PAD FOR ATTACHING OBJECTS WITH SUCTION DISC

(76) Inventor: Eagle Fan, Hsinchu (TW)

(21) Appl. No.: 12/582,522

(22) Filed: Oct. 20, 2009

(51) Int. Cl. F16M 13/00

(52) U.S. Cl. 248/346.03

(57) ABSTRACT

A soft pad for attaching object with suction disc is provided, including a metal object unit and a wrapping unit. The metal object unit is made of material with good ductility, shaped as a flat plate. The plate includes a fixed region and a bendable region surrounding the fixed region. The top surface of the fixed region includes a suction surface for placing the object with suction disc. The bendable region is bendable to achieve better fit to the curvy surface. The wrapping unit completely wraps around the metal object, except the suction surface. The suction surface is exposed. Furthermore, the bottom of the soft pad is the wrapping unit, thus is an anti-slippery surface that is soft, flat, and having high friction coefficient. In this manner, the soft pad can be slightly bended to fit the curvy surface. With large contact area, good fitness, and considerable weight, the soft pad can be stably placed to provide attachment to holder with suction disc.

### FIELD OF THE INVENTION

The present invention generally relates to a soft pad, and more specifically to a soft pad for placing objects with suction disc on top, said object having suction disc being a clapping device for clapping various electronic apparatus in flat or non-flat surface inside vehicles.

### BACKGROUND OF THE INVENTION

Portable electronic devices, such as, GPS, PDA or DVD players, are widely used in vehicles. For convenience, when the aforementioned electronic devices are used in vehicles, a supportive holding device must be installed in the vehicle to hold the electronic devices. At present, some holding device in the market uses a suction disc as the bottom so that the holding device can be attached to the windshield. However, this type of suction holding device is prohibited in some countries due to the safety concern for blocking the driver's view. To solve the problem, a suction base is provided by gluing the base to dashboard of the vehicle to provide anchor place for the holding device with suction disc. The suction base usually includes a flat surface to provide the place for the suction disc of the holding place to attach to. However, this type of solution has the following disadvantages:
1. Residual glue damaging the dashboard after the suction base is removed; and
2. Flat suction base might not completely fit curvy dashboard, thus the attachment holding is not sufficiently strong.

Hence, it is imperative to devise a product that can be steadily placed on the dashboard, either flat or non-curvy, to provide a surface for a suction disc to attach to.

### SUMMARY OF THE INVENTION

The primary object of the present invention is to provide a soft pad for attaching objects with suction disc. The soft pad uses a large-area wrapping unit to directly attach to a placement surface. In combination with the concealed metal heavy object, with the following three factors: large-area contact, proper bending, and considerable weight of metal, when placed on a surface without gluing, such as dashboard, the soft pad can still provide good stability and attachment, while avoiding the aforementioned disadvantages of conventional solutions.

Another object of the present invention is to provide a soft pad that is easy to manufacture. The soft pad is made of two materials. For manufacturing, the rubber material for the wrapping unit can be poured or inject molding to wrap around the metal object unit. After solidified, the final form is finished. Because the bottom surface of the wrapping unit is soft and slightly viscous, thus high friction and display high stability when placed on a surface. To further increase the friction, an additional weight can be added to the metal object unit.

To achieve the above objects, the present invention provides a soft pad, including a metal object unit and a wrapping unit. The metal object unit is made of material with good ductility, shaped as a flat plate. The plate includes a fixed region and a bendable region surrounding the fixed region. The top surface of the fixed region includes a suction surface for placing the object with suction disc. The bendable region includes a plurality of holes so that the bendable region can have a mesh appearance. Alternatively, the bendable region can include a plurality of stripes to increase the bendability. The wrapping unit completely wraps around the metal object, except the suction surface. The suction surface is exposed. Furthermore, the bottom of the soft pad is the wrapping unit, thus is an anti-slippery surface that is soft, flat, and having high friction coefficient.

An advantage of the present invention is to provide a soft pad with good attachment. The mesh-like design of the bendable region provides better flexibility. With slight bending, the bendable region can better fit the curviness of the surface to be placed on to achieve better attachment. The metal material used in the bendable region also provides weight and strength so that when a holder with suction disc is placed on the soft pad, the center of mass will not tip over the holder.

Another advantage of the present invention is the strong engagement of wrapping unit and the metal object unit. Because the holes of the bendable region are filled with the material forming the wrapping unit. In this manner, the layer above the metal object unit and the layer below the metal object layer is connected with the material filling the holes in the metal object unit to provide enhanced holding.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the first embodiment of the present invention;

FIG. 2 shows an AA cross-sectional view of FIG. 1;

FIG. 3 shows a schematic top view of metal object unit of the present invention;

FIG. 4 shows a schematic view of the first embodiment in actual application;

FIG. 5 shows a cross-sectional view of the second embodiment of the present invention;

FIG. 6 shows a cross-sectional view of the third embodiment of the present invention;

FIG. 7 shows a cross-sectional view of the fourth embodiment of the present invention;

FIG. 8 shows a schematic top view of metal object unit of the fifth embodiment of the present invention;

FIG. 9 shows a cross-sectional view of the sixth embodiment of the present invention; and

FIG. 10 shows a schematic top view of metal object unit of the seventh embodiment of the present invention.

### DETAILED DESCRIPTION OF THE PREFERRED EMBODIMENTS

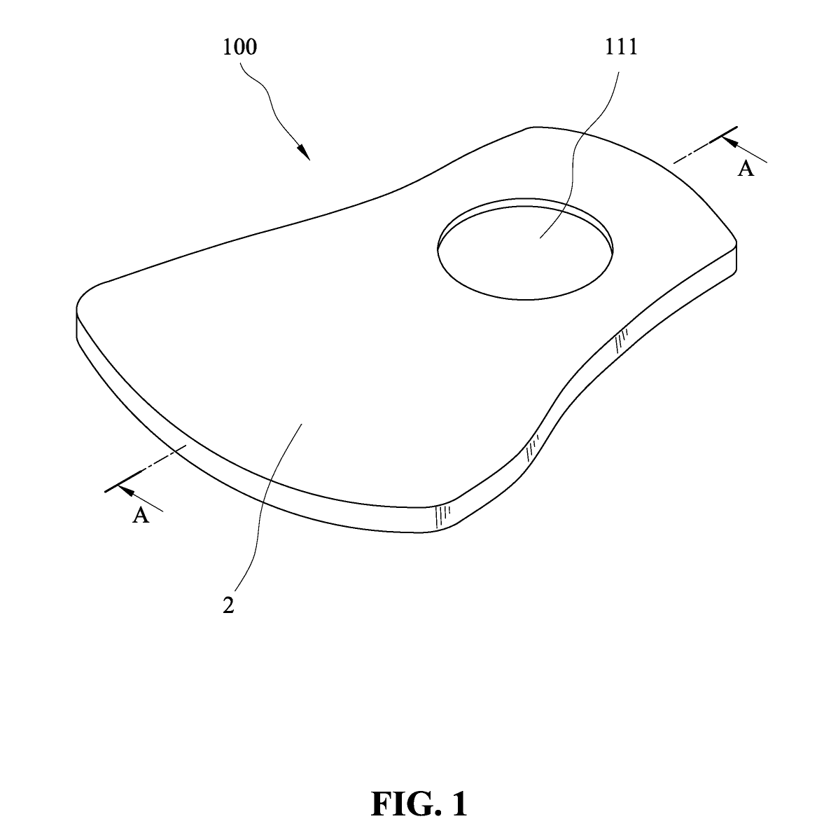

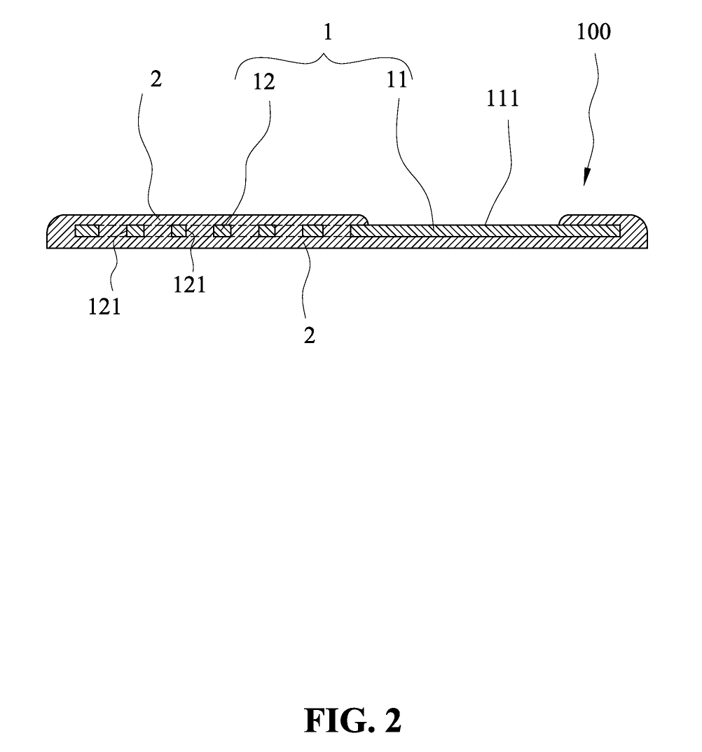

FIG. 1 and FIG. 2 show a schematic view and a cross-sectional view of the first embodiment of the soft pad for attaching object with suction disc according to the present invention. Soft pad 100 includes a metal object unit 1 and a wrapping unit 2. Wrapping unit 2 is made of soft resilient rubber-like material, such as, polyurethane (PU) or TRP. Wrapping unit 2 wraps around metal object unit 1, with only suction surface 111 at the top surface of metal object unit 1 exposed. Suction surface 111 is a smooth surface, can be higher than, the same as or lower than the top surface of bendable region 12. In the present embodiment, suction surface 111 is a flat smooth surface for the suction disc of a holder to attach to.

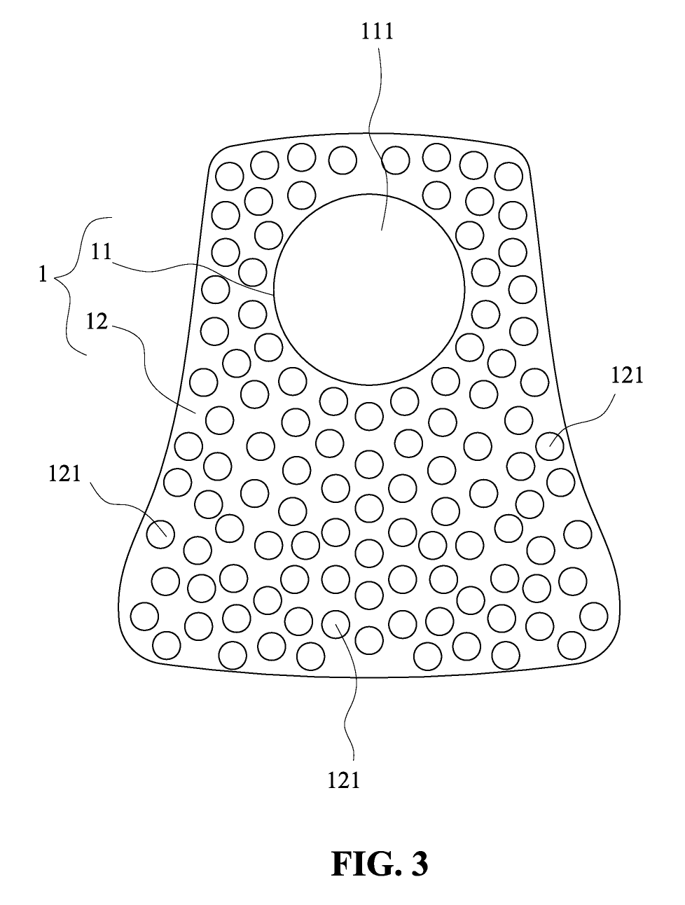

As shown in FIG. 2 and FIG. 3, metal object unit 1 is a plate, including a fixed region 11 and a bendable region 12 surrounding fixed region 11. The top surface of fixed region 11 is suction surface 111. This region is stronger and thus not bendable. The shape of suction surface 111 is not limited to circular, as long as sufficient area for the suction disc is provided by the suction surface. In addition, the shape of suction surface 111 is not necessarily the same as the shape of fixed region 11. Bendable region 12 includes all the remaining area of metal object unit 1 except fixed region 11. In the present embodiment, bendable region 12 surround fixed region 11. It is preferable that bendable region 11 should be larger than fixed region 11, preferably at least twice large. Bendable region 12 includes a plurality of holes 121. The total area of holes 121 is preferably more than ¼ of the area of bendable region 12, even more preferably more than ⅓. In this manner, bendable region 12 is even more bendable. In the present embodiment, metal object unit 1 is made of material with good ductility, such as, Al, Cu, or Pb. In addition, the shape of holes 121 is not limited to circular, and any arbitrary shape is allowed.

When wrapping unit 2 wraps around metal object unit 1, the material forming wrapping unit 2 will also fill holes 121 of bendable region 12. In this manner, bendable region 12 and wrapping unit 2 will stay engaged even after repeatedly bending for many times.

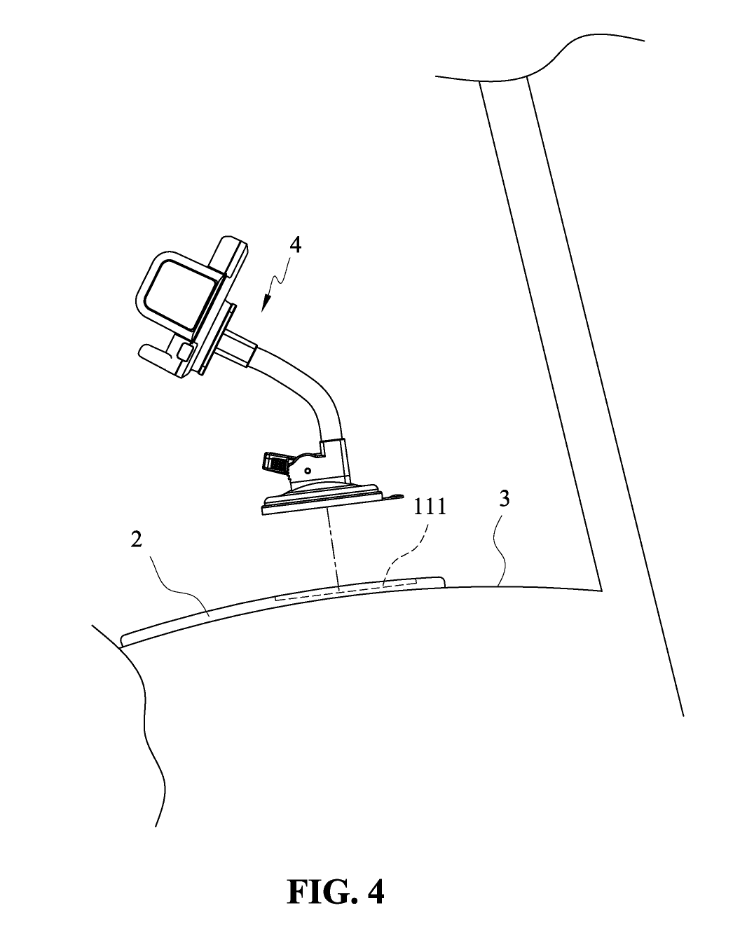

FIG. 4 shows a schematic view of the present invention in actual application. When soft pad 100 is in use, the bottom of wrapping unit 2 is placed on a surface 3. As shown in FIG. 4, surface 3 is the surface above the dashboard. With the weight and large area of metal object unit 1, the friction of the contact area between surface 3 and wrapping unit 2 is large. Furthermore, bendable region 12 wrapped by wrapping unit 2 can be bended to fit the curve of surface 3 so that a better attachment of soft pad 100 on surface 3 can be achieved. With the characteristics of large contact area, good attachment and fitness, and considerable weight of metal object unit, soft pad 100 can be stably placed on surface 3 without the conventional gluing mechanism. In addition, suction surface 111 of fixed region 11 is rigid, flat and smooth to provide good surface to suction disc of a holder 4 to attach to in order to hold a portable electronic device.

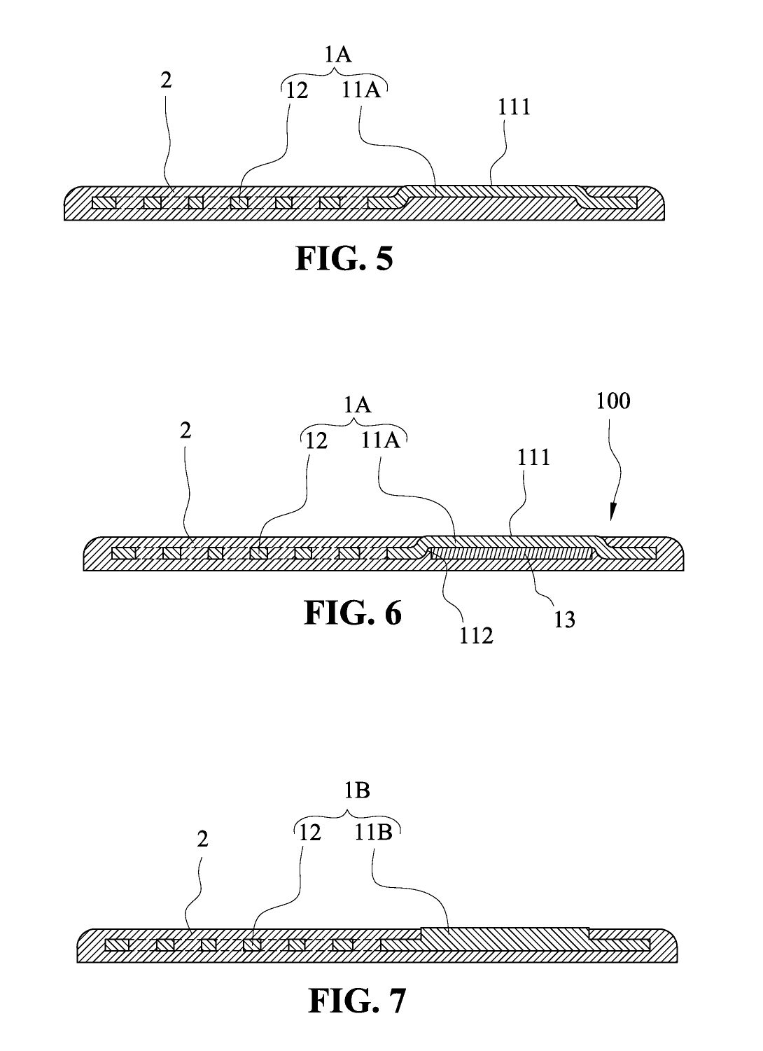

FIG. 5 shows a cross-sectional view of the second embodiment of the present invention. As shown in FIG. 5, metal object unit 1A of the present embodiment is similar to that of the first embodiment, with the difference that suction surface 111 of fixed area 11A is higher than the top surface of bendable region 12. The purpose is to enhance the rigidity and the strength of fixed region 11 so that suction surface 111 will not be distorted due to the bending of bendable region 12. In addition, when wrapping unit 2 wraps around metal object unit 1, the top surface of wrapping unit 2 can be at the same level as suction surface 111 to provide better aesthetics of soft pad 100.

FIG. 6 shows a schematic view of the third embodiment of the present invention. As shown in FIG. 6, the difference between the present embodiment and the second embodiment in FIG. 5 is that fixed region 11A is raised to form a housing space 112 below fixed region 11A to house a weight block 13. Weight block 13 is preferably made of a heavier metal to increase the overall weight of soft pad 100.

FIG. 7 shows a schematic view of the fourth embodiment of the present invention. As shown in FIG. 7, the difference between the present embodiment and the third embodiment in FIG. 6 is that fixed region 11B is raised in height to provide more weight, and no additional weight block is included.

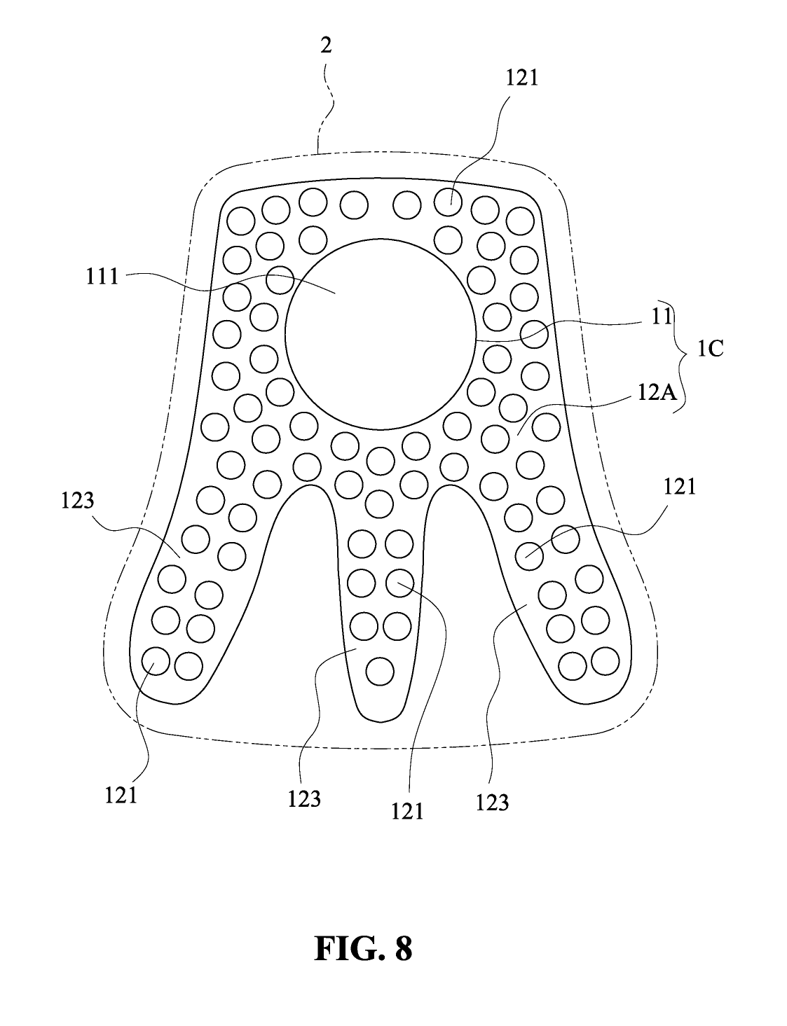

FIG. 8 shows a schematic view of the fifth embodiment of the present invention. As shown in FIG. 8, the different between the present embodiment and the first embodiment of FIG. 3 is that bendable region 12A of the present invention is not a simple geometric shape, such as the shape of the shield. The shape of bendable region 12A of the present embodiment includes three extended regions 123 with a plurality of holes 121. The dash line of FIG. 8 is the default coverage area of wrapping unit 2. In this manner, after wrapping unit 2 wraps around metal object unit 1C, the shape of soft pad 100 is still the shape of shield as the first embodiment. The advantage of this embodiment is to provide even further flexibility in bending bendable region 12 to achieve better fitness to the placement surface. As shown in the present embodiment, the final shape of wrapping unit 2 is not necessarily the same as the shape of metal object unit 1C.

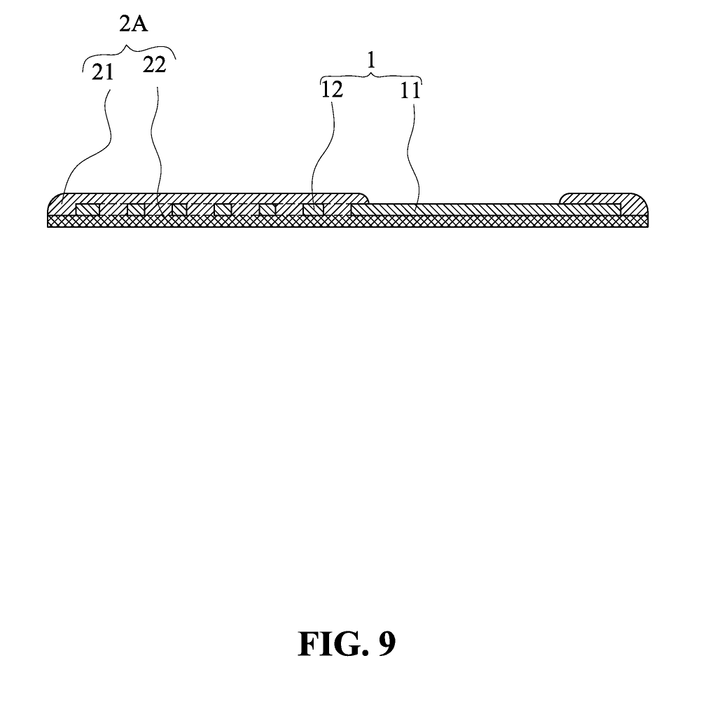

FIG. 9 shows a schematic view of the sixth embodiment of the present invention. In the previous embodiments, wrapping unit 2 is made of a single material. In this embodiment, wrapping unit 2A includes an upper part 21 and a lower part 22 of different hardness. Lower part 22 is softer than upper part 21. Wrapping unit 2 can be made of two different materials or a single with two different processes. In the present embodiment, the same PU material is sued, but with two different forming processes adding different ingredient to make the final parts of different hardness. In this manner, the engagement bond between the upper part and the lower part will also be stronger.

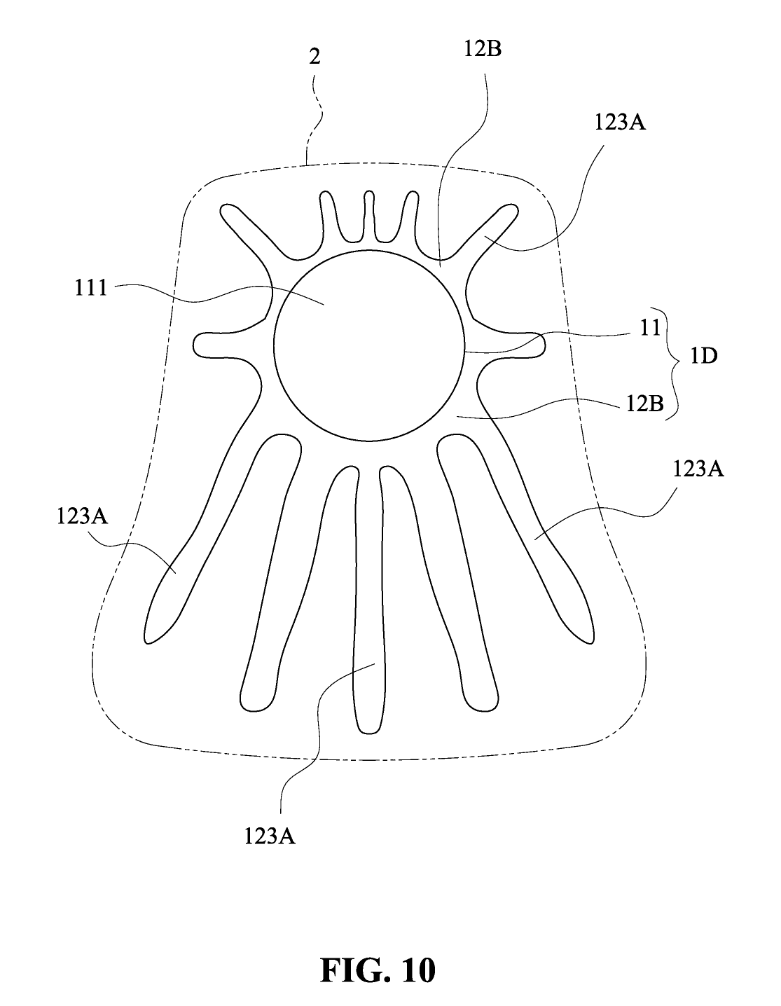

FIG. 10 shows a schematic view of the seventh embodiment of the present invention. As shown in FIG. 10, the difference between the present embodiment and the fifth embodiment of FIG. 8 is that bendable region 12B does not include any holes. Instead, bendable region 12B includes a plurality of extended regions 123A. The width is extended regions 123A is much narrower than that of extended region 123. Also, metal object unit 1D also includes fixed region 11 and bendable region 12B. Wrapping unit 2 still wraps around metal object unit 1D with suction surface 111 exposed. The dash line in FIG. 10 shows the default area covered by wrapping unit 2. The bendable region can also be thinner, yet without extended regions. Metal object unit 1D is made of material with good ductility, such as, Al. In this way, the curvature achieved by bendable region would be less.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A soft pad for attaching object with suction disc, comprising: a metal object unit and a wrapping unit;
wherein said metal object unit being a plate with good ductility, said plate having a fixed region and a bendable region surrounding said fixed region, said fixed region having a suction surface at top for providing surface for said suction disc to attach to, said bendable region having a plurality of holes so that said bendable region being able to bend; said wrapping unit wrapping around said metal object unit with only said suction surface exposed, bottom of said soft pad being an anti-slippery soft surface formed by said wrapping unit.

2. The soft pad as claimed in claim 1, wherein said fixed region is raised.

3. The soft pad as claimed in claim 1, wherein a weight block is engaged to the space formed by said raised fixed region.

4. The soft pad as claimed in claim 3, wherein said weight block is made of metal of different material from said metal object unit.

5. The soft pad as claimed in claim 1, wherein said suction surface of said fixed region can be higher than, same as, or lower than top surface level of said wrapping unit.

6. The soft pad as claimed in claim 1, wherein area of said bendable region of metal object unit is larger than area of said fixed region.

7. The soft pad as claimed in claim 1, wherein total area of said holes of said bendable region is more than ⅓ of area of said bendable region.

8. The soft pad as claimed in claim 1, wherein said wrapping unit further comprises an upper part and a lower part, and said lower part is softer than said upper part.

9. A soft pad for attaching object with suction disc, comprising a metal object unit and a wrapping unit;
wherein said metal object unit being a plate with good ductility, said plate having a fixed region and a bendable region surrounding said fixed region, said fixed region having a suction surface at top for providing surface for said suction disc to attach to, said bendable region being able to bend; said wrapping unit wrapping around said metal object unit with only said suction surface exposed, bottom of said soft pad being an anti-slippery soft surface formed by said wrapping unit.

10. The soft pad as claimed in claim 9, wherein said bendable region comprises a plurality of extended regions.

11. The soft pad as claimed in claim 10, wherein said bendable region and said extended region comprise at least a hole.
